(19) United States
(12) Patent Application Publication
(10) Pub. No.: US 2007/0180850 A1
(43) Pub. Date: Aug. 9, 2007

(54) Plastic freezable food container

(76) Inventor: Jeffrey Brent Thompson, Walled Lake, MI (US)

Correspondence Address: Jeffrey Thompson, 3055 Linda Marie Way, Walled Lake, MI, 48390, US

(21) Appl. No.: 11/347,588

(22) Filed: Feb. 4, 2006

(51) Int. Cl. A61J 3/07; F25D 3/08

(52) U.S. Cl. 62/457.2; 62/457.6; 62/530; 264/4

(57) ABSTRACT

An article of manufacture for making and producing a plastic three layer freezable food containers with food containers preferably made of plastic analogous to Rubbermaid and Tupperware containers. The container defines a volume with an inner surface of plastic for supporting a food product. The container defines a second wall of plastic in which the container has a freezable layer of blue gel that is sealed between the first and second walls of plastic and the freezable layer is made of freezable material such as “Blue Ice” which enhances the chilling of the food products supported in the volume. The container has a third layer of plastic which creates a insulating layer of air to help absorb and insulate the second frozen layer from the outside temperatures therefore helping to maintain refrigerated temperatures in the inner container surface of plastic for up to 8 hours in a stand alone situation.

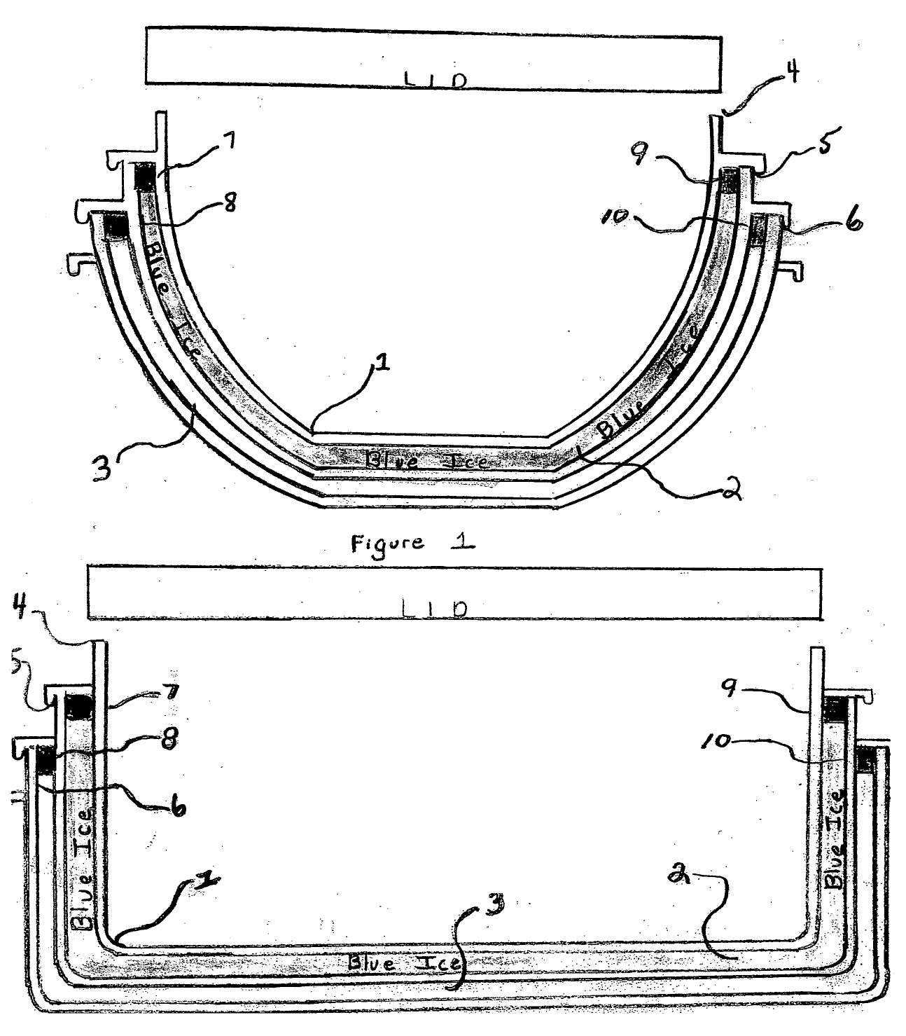

An article of manufacture for making and producing plastic freezable food containers and process for making same.

### BACKGROUND OF THE INVENTION

This invention relates generally to the field of food containers and more specifically to an article of manufacture for making and producing plastic freezable food containers and process for making same.

There are many bowls and containers on the market in which food is stored and carried from place to place in lunch boxes or coolers, lunch bags, brief cases the problem evolves because the food being transported in said containers is hard to maintain cold temperature inside that container. For instance, carrying a salad to work for lunch or dinner or fresh fruit or fresh vegetables because it is necessary to add some kind of a freezable device along side the container to help keep the container cold.

Therefore, it is desirable to develop a self contained plastic refreezable container that can be reused over and over that can maintain refrigerated temperatures in a stand alone container for extended hours at a time creating an acceptable cooler temperature before eating.

### BRIEF SUMMARY OF THE INVENTION

The primary object of the invention is to provide a plastic food container that is reusable.

Another object of the invention is to provide a plastic food container that is freezable and refreezable.

Another object of the invention is that it can maintain refrigerated temperatures inside the plastic containers for up to 8 hours with the lid on. A further object of the invention is plastic food containers can be produced in all shapes and sizes.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is a disclosed article of manufacture for making and producing plastic freezable food containers comprising: a food container preferably made of plastic, analogous to Rubbermaid and Tupperware containers; the container defines a volume with an inner surface of plastic for supporting a food product; the container defines a second wall of plastic, which has a freezable layer that is sealed between the first and second walls of plastic; and the freezable layer is made of freezable material such as “Blue Ice” which enhances the chilling of the food products supported in the volume.

The container defines a third layer of plastic which is a sealed layer of air to help insulate and preserve the temperature of the freezable layer.

In accordance with a preferred embodiment of the invention, there is a disclosed process for making and producing plastic freezable food containers comprising the steps of: a food container preferably made of plastic, analogous to Rubbermaid and Tupperware containers; the container defines a volume with an inner surface of plastic for supporting a food product; the container defines a second wall of plastic; the container has a freezable layer that is sealed between the first and second walls of plastic; and the freezable layer is made of freezable material such as “Blue Ice” which enhances the chilling of the food products supported in the volume.

The container defines a third layer of plastic that works as a insulating layer to help in the prevention of sweating or moisture which can collect on the outside.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. <1> Shows a cross sectional view of the container and bowl showing the inner surface of plastic for supporting a volume of food 1.

It also shows between the first and second walls of plastic a freezable layer of blue ice 2 which maintains the cold temperature of the volume of the inner surface 1 for extended period with lid in place.

The bowl or container shows a insulated layer of air between the second and third walls of plastic 3 which help protect the freezable layer 2 from the outside elements preventing excessive sweating of the bowl or container.

4.5.6. represent the three layers of plastic that are fused together 7.8.9.10. by a welding process to encompass the bowl or container as one unit.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Plastic Freezable Food Container

This is an article of manufacture for the process of making and producing plastic freezable bowl food containers of all sizes and shapes. The bowl creates a stand alone container for the uses of keeping food, fruits, vegetables, salads, meat, fish cold for extended periods of time. Once the bowl or container is frozen in a conventional freezer it can be used outside the freezer for up to 8 hours maintaining a cool refrigerated temperature all by itself.

This is a bowl or other shape plastic container. For example, rectangular, square, round or oblong which is constructed of three layers of plastic which has a inner layer of plastic for supporting food.

A second freezable layer filled with a blue gel like substance better known as Blue Ice which is freezable between the inner and second layers of plastic, the third layer is a thermal layer of air sealed between the second and third layers of plastic to help insulate the freezable second layer.

The plastic bowls or containers are fused together by a plastic welding process and then are filled with Blue Ice installed in the inner layer or middle of the bowl or container leaving a air gap for expansion and contraction in the freezing process where it is then sealed shut with same plastic welding process and a third layer is added creating a insulating layer to help preserve the temperature of the second layer.

This process could be used in the food service industry with using larger freezable containers for salad bars where common ice cubes are used to maintain cool areas throughout salad bars.

One of the largest benefits of this product is its ability to be cleaned and refrozen and reused on a daily basis for someone that likes to take a salad for lunch and doesn't have the ability to refrigerate their lunch. This bowl or container will maintain a very cold temperature for up to 8 hours.

Another benefit of these bowls are the larger the bowl is one could take a large freezable bowl full of potato salad to a family picnic and keep it cold without refrigerating it.

Another advantage of this product would be the bowls third layer which prevents condensation to the outside of the bowl or container.

Another advantage of the third layer would be that it would help insulate the bowl or container and help maintain a refrigerated temperature longer.

Another advantage of this product would be when transporting this bowl or container in your brief case or lunch box or lunch bag it will not moisten other things that come in contact with the bowl or container do the third layer of protection.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for making producing plastic freezable food containers comprising:
A food container preferably made of plastic, analogous to Rubbermaid and Tupperware containers;
The container defines a volume with a plastic inner surface for supporting a food product;
The container defines a second wall of plastic;
The container has a freezable layer that is sealed between the first and second walls of plastic;
The freezable layer is made of freezable material such as “Blue Ice” which enhances the chilling of the food products supported in the volume.
The container defines a second thermal insulating layer of air sealed between the second and third walls of plastic.
In a preferred embodiment of the invention, the third layer becomes a insulated thermal layer between the second and third walls of plastic.
The third insulating layer reduces the likelihood of condensation on the outer surface of the food container or bowl and also reduces the rate of heat transfer between the environment and the first thermal insulating layer. In other words, the chilled volume can be maintained much longer because of the third thermal insulating layer of plastic.

2. A process for making producing plastic freezable food containers comprising the steps of:
A food container preferably made of plastic, analogous to Rubbermaid and Tupperware containers;
The container defines a volume with an inner surface of plastic for supporting a food product;
The container defines a second wall of plastic;
The container has a freezable layer that is sealed between the first and second walls of plastic.
The freezable layer is made of freezable material such as “Blue Ice” which enhances the chilling of the food products supported in the volume.
The container defines a third wall of plastic sealed between the second wall of plastic creating a insulating thermal layer of air.
